(19) United States
(12) Patent Application Publication
(10) Pub. No.: US 2005/0267984 A1
(43) Pub. Date: Dec. 1, 2005

(54) Method and apparatus for interoperability and relay for WV and IMS group management services

(76) Inventors: Jose Costa-Requena, Helsinki (FI); Jyrki Aarnos, Kangasala (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/824,934

(22) Filed: Apr. 14, 2004

(51) Int. Cl. H04L 12/28

(52) U.S. Cl. 709/238

(57) ABSTRACT

A relay server (11) including functionality for enabling a user in one domain to perform a group operation on a group used by a service in another domain, and so hosted by a server in the other domain. A predetermined list (11e) of mappable group commands, i.e. a table of mappings of group operation commands/ primitives is used. If the group command is not in the list of mappable group commands and so is not mappable, then the relay server copies the group from the other domain to the user domain, and binds the group to an approximately equivalent service in the user domain if there is one according to a predetermined list (11f) of such equivalents, but otherwise notifies the user that the group is available locally, and user interaction is required to bind the group to a service in the user domain.

### TECHNICAL FIELD

The present invention relates to the use of a wireless communication protocol in one domain for performing an operation in another domain, i.e. to interoperability across domains. More particularly, the invention relates to management of a group (a list of entities) hosted in one domain, such as the WV domain, by a user in another domain, such as the IMS domain, using a protocol prescribed for use in the other domain.

### BACKGROUND ART

It would be advantageous for a user either in the IMS (Internet protocol Multimedia Subsystem) domain or the WV (Wireless Village) domain to be able to access and manage groups created in either of the domains, i.e. independent of the domain of the user.

The prior art provides a mechanism by which a message for an entity in another domain is routed to the other domain. If for example a user in the IMS domain wants to send a message to a user in the WV domain, the sending user includes in the message the URI (uniform resource identifier) for the destination user according to the “wv” schema, i.e.e.g. wv:john.doe@domain-name). The message itself, however, is according to the format prescribed for use in the IMS domain. Since the destination user URI uses a “wv” schema, it is clear that the destination is the WV domain, and so the message is routed to the WV domain via e.g. a gateway or relay. The gateway or relay identifies the schema and translates it into the message format appropriate for the WV domain.

When the destination is a group for use as part of a service (e.g. instant messaging) in another domain, the message can still be routed to the other domain based on the address schema. However, the manipulation of group data for a group of a service provided in another domain—i.e. the manipulation of the members of the group and other information related to the group—must be done by a user using a group manipulation protocol designed for use with the service using the group. The service in the other domain is (by definition, i.e. because of the domains being different) not available in different domains, and so a user in one domain cannot, according to the prior art, manage a group hosted in another domain (on a server in the other domain) without some kind of intermediary.

### DISCLOSURE OF THE INVENTION

Accordingly, in a first aspect of the invention, a method is provided for use by a relay server in enabling a user in one domain to perform a management operation on a group stored in another domain via a message according to a protocol used in the user domain and bearing a group command according to a group operation protocol used in the user domain, but indicating a group of a service provided in the other domain, the method comprising: a step of identifying the group command in the message; and a step of determining whether the group command is mappable to one or more group commands in the other domain providing an approximate equivalent to the group operation provided by the identified group command, by comparing the identified group command with a predetermined list of mappable group commands indicating, for each mappable group command in the one domain, one or more group commands in the other domain.

In accord with the first aspect of the invention, the method may further comprise a step, performed if the identified group command is determined to be mappable to the other domain, of translating the message so as to be in a form used in the other domain, and substituting for the identified group command the one or more group commands in the other domain to which the identified group command is mappable, according to the predetermined list of mappable group commands.

Also in accord with the first aspect of the invention, the method may further comprise a step of determining whether the group indicated in the message in the other domain is used by a service that is approximately equivalent to a service in the domain of the user, by comparing the service indicated in the message with a predetermined list of approximately equivalent services. Further, the method may also comprise a step, performed if the service is found to be included in the list of approximately equivalent services and so has an approximate equivalent in the user domain using a corresponding type of group but also determining that the group command is not mappable, of copying to a group server hosting the corresponding type of group in the user domain the group in the other domain, followed by a step of binding the group to the approximately equivalent service in the user domain. Also further, the method may also comprise a step, performed if the service is not found to be included in the list of approximately equivalent services, of copying to a group server in the user domain the group in the other domain, followed by a step of notifying the user that the group is available in the user domain but user action is required to bind the group to a service.

Also in accord with the first aspect of the invention, one of the domains may be 3GPP (third generation partnership program) IMS, and the other may be WV, and further, if the message originates from the 3GPP IMS domain, the group command may be provided in a message according to one or another addressing protocol including SIP (session initiation protocol), PRES (presence), IM (instant messaging), and if the message originates from the WV domain, the group command may be provided in a message according to one or another addressing protocol including CSP (command server protocol). Further, if the message originates from the 3GPP IMS domain, the group command may be provided according to XCAP (Extensible markup language (XML) Configuration Access Protocol), and if the message originates from the 3GPP WV domain, the group command may be provided according to the CSP protocol.

In a second aspect of the invention, a computer program product is provided comprising: a computer readable storage structure embodying computer program code thereon for execution by a computer processor in a server, with said computer program code characterized in that it includes instructions for performing the steps of a method according to the first aspect of the invention.

In a third aspect of the invention, an apparatus is provided corresponding to a method according to the first aspect of the invention, and so for use as part of a relay server in enabling a user in one domain to perform a management operation on a group stored in another domain.

In a fourth aspect of the invention, a system is provided, comprising a relay server including an apparatus according to the third aspect of the invention, and also comprising a UE (user equipment) device for use in one of the domains, and further comprising a routing server for examining the message and determining whether the message is directed to the other domain, and if so, for routing the message to the relay server.

In a fifth aspect of the invention, a UE device is provided, comprising: means for providing a group command for managing a group in a destination domain different from the domain to which the UE device is subscribed but using a group command protocol prescribed for use in the domain to which the UE device is subscribed, the group command including information sufficient to identify the group in the destination domain; and means, responsive to a notice indicating the group command is not mappable to an approximately equivalent command in a destination domain, for providing in response a notice of same for display to a user, the notice indicating that the group information cannot be mapped properly because at least some of the group information is incompatible with group information in the destination domain.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram showing a relay server according to the invention, and its coupling to servers in two different domains, and also showing components of the relay server providing functionality according to the invention.

FIG. 2 is a flow chart illustrating actions of the relay server of FIG. 1 in response to receiving a message from a user indicating a group in another domain.

### DETAILED DESCRIPTION OF THE INVENTION

The invention provides a group relay server that allows a user in one domain—such as IMS—to perform a group operation on a group in another domain—such as WV—by either translating the corresponding group command to the protocol used in the other domain, or copying the group from the other domain into the user domain in order to give the user access to the group in the user domain. The copying is done in different ways, depending on whether the group in the other domain is used by a service there for which there is some kind of equivalent in the user domain. The IMS domain and the WV domain are used here throughout in order to give concrete examples of the use of the invention, but the invention is of course not limited in its applicability to the IMS and WV domains. It is of use in case of any two different domains, i.e. in case of a user in any first domain attempting to manage a group in another domain (on a group server in the other domain).

In managing a group, a user uses a command provided by a group management protocol in the user domain, i.e. in the domain to which the user is subscribed by virtue of subscribing to a home telecommunication network. Each such (operator) network implements services available in one or another domain providing services that can involve groups—using IMS and WV as examples of such domains.

A group management protocol used in IMS is XCAP. It provides its own so-called primitives (i.e. commands) for managing a group (e.g. adding a member to the group). In IMS, there is only one kind of group—a PMG (presence and messaging) group—and several different services (presence, messaging, chat) all use such a group. Thus, for any group operation in IMS, a user uses XCAP to perform group operation. Both the format of a message using the XCAP primitives, and usually also the primitives themselves, differ from what is used in a domain not providing XCAP, such as WV, which provides various different services and corresponding groups.

According to the invention, however—i.e. despite the fact that XCAP is not recognized in the WV domain—a user in the IMS domain is able to manage a group in the WV domain using a message including XCAP primitives, such as the following (using two primitives—PUT and DELETE):
PUT http://xcap.example.com/wv-services/presence-lists/users/joe/mybuddies HTTP/1.1
DELETE http://xcap.example.com/wv-services/presence-lists/users/bill/fr.xml?presence-lists/list/list/entry[@name=“Petri”] HTTP/1.1
   The reference to wv-services in the URI for each primitive is a reference to the IMS-WV relay provided by the invention and used to map/ translate each XCAP primitive into one or more corresponding WV group operations.

In general, such a mapping from one domain to another can be made one-to-one only for a limited set of group operations, those that have the same semantics in both directions (i.e. IMS over into WV and WV over into IMS). The description here gives examples of mappings that can be performed by a relay server provided according to the invention.

In case of group operations that cannot be mapped (e.g. from the IMS domain to the WV domain or vice versa), the relay server provided by the invention still responds usefully to group commands issued by a user in one domain for managing a group in another domain, but in such a case (of non-mappable commands), instead of mapping the commands, as mentioned above the relay server copies the group into the user domain (and does so in different ways, depending on the services in the two domains, as described below).

In the WV and IMS domains, the concept and structure of a group is different. As mentioned above, there are only a PMG type of group in IMS. In the WV domain, the concept of user group means a discussion forum (set of users) formed by two or more individuals (users) to exchange information, opinions, comments, or thoughts about a particular issue that is the topic of the particular forum. WV groups contain a set of group properties, a collection of users, and their member properties. These groups are oriented to a chat session messaging service. In that sense, the group properties and the member properties are specialized for this kind of service. The groups in WV can also be used for session-less instant messaging, serving as “delivery lists” in such cases. Thus providing a mapping from IMS to WV (or vice versa) is problematic in general, and according to the invention, to the extent that such a mapping can be provided, a WV-IMS relay implements a mapping for each service.

From the interoperability point of view, a relay according to the invention responds to a message bearing group management commands from a user in one domain and directed to a group server in another domain, for managing a group maintained by the server in the other domain, in one of three ways. The first way is performed in case the group management commands are mappable, which requires both that there be approximately equivalent primitives that work in approximately the same way, for use on groups associated with approximately the same service. If the group command are mappable, then the relay transparently (without involving the user) translates the group management commands across the domains and routes them to the other domain. The relay server then relays back to the user any provisional or final responses from the group server in the other domain.

The second and third ways are performed in case the group management commands are not mappable. This can happen because either there is no approximately equivalent service in the other domain (independent of whether there is a command that performs somewhat the same operation), or because even though there is an approximately equivalent service, there is no corresponding command. In case there is no corresponding command but there is an approximately equivalent service, the relay server copies the group to the group server of the user domain that provides the approximately equivalent service, transparently adapting the group from the other domain for use in the user domain by the approximately equivalent service.

In case there is no corresponding command and, in addition, there is no approximately equivalent service, the message from the user must somehow indicate the group or service in the other domain, and the relay server copies the group (as merely a list of addresses) to either the user equipment or to a predetermined default group server, and so makes the group available to the user for performing group management operations using a protocol available in the user domain. The copying in this way is here called pure copying. (In case the two domains are WV and IMS, there is always an approximately equivalent service. In general, normally presence and messaging services are offered in any domain. One thing to note is that in WV the groups bound to chat or presence may have additional service information such as associated authorization information, i.e. associated presence information visible only to the group. Also, the chat service in WV may have a nick name, rights, etc. When the relay copies such groups from a first domain per the pure copying mode of operation of the invention, even though a similar service exists in the second domain, the service specific information are removed from the group and only the names and URIs are copied into the new domain.)

In determining whether an approximately equivalent group operation and service exists in the other domain, a relay server according to the invention uses what in essence is a table providing predetermined mappings. The non-existence of an approximately equivalent group or service is indicated either by the absence of a mapping or by a null mapping—an entry for the group and service in one domain, and no corresponding entry for one or both in the other. The copying here is called copying to a local service, as opposed to the pure copying in case of no approximately equivalent service.

In case of copying to a local service, the relay server advantageously copies the group onto a group server (for the approximately equivalent service) in the user domain as a list of addresses and associated properties/related fields, adapts them as required for use by the approximately equivalent service (i.e. maps and copies all group information from the other domain into corresponding fields in the user domain as long as the information exists in both domains, i.e. as mentioned above, some properties may not be copied since it is better not to copy such information than to assign wrong service attributes to the information), and then makes the group available to the user using group commands of the group protocol used in the user domain. The process here is therefore more than a simple copying of addresses. It entails transparently (without user involvement) moving information stored in various fields of group records in the other domain into corresponding, predetermined fields of group records in the user domain. The process of copying the group information into the various fields of the group records used by the approximately equivalent service in the user domain is sometimes called “binding” the group to the service in the user domain.

In case of pure copying, the user must indicate the service in the other domain, and could also indicate a group server in the user domain. Because there is no approximately equivalent service, the binding cannot be done transparently, and so after the relay server copies the indicated group in the other domain to the indicated group server in the user domain, the server must manually perform the binding.

Besides the pure copying to an indicated group server, a relay server according to the invention is also responsive to a simple “GetGroup” type of command issued by a user, in which case it obtains a copy of an indicated group in the other domain, and merely copies it to the user equipment for whatever use the user would like to make.

Binding is, in general, necessary because although some groups are simply a collection of users (i.e. user addresses) without associated service data, other groups have some semantics associated with them, as in the case of a WV Presence “Contact List” having Presence Attributes. In such a case the Presence Attributes are, according to the invention, advantageously preserved as Group Properties when converting the WV Presence “Contact List” to an IMS group (there being only one type of IMS group—a PMG group). Another example of copying to a group is copying a WV Block List used in the WV IM service to a Block list in the equivalent IMS Service, i.e. the IMS IM Service, which includes what has been referred to as the automatic/transparent binding process (i.e. moving the information in each field of the group in the other domain into a corresponding field in the group of the user domain, without user involvement).

An example of pure copying is a user issuing a command by which a relay according to the invention is prompted to copy a WV group to an IMS server for use in a service provided by IMS. The relay server, in such a use case, provides the user equipment with all the WV Entities (WV group, WV Contact List, WV Block List, WV Grant List, WV Reject List, etc.) the user owns/ is authorized to access.

For copying to a group in case of the two domains being WV and IMS, the following table (Table 1) indicates the groups in the two domains that map into each other.

TABLE 1

| | | | (IMS) | (IMS) | |
|---|---|---|---|---|---|
| WV | WV | | PMG | PMG | |
| Related | Entity | Usage in Wireless | Related | Entity | (IMS) |
| service | (Group) | Village | service | (Group) | Usage in PMG |
| Presence | Contact | Proactive authorization | Presence | Groups | Allow list/Deny List |
| | List | together with attribute | | | used in proactive |
| | | lists | | | authorization together |
| | | | | | with the Presence |
| | | | | | TupleList |
| | Contact | Subscribe to contact list | | | Subscribe to Buddy List |
| | List | | | | |
| Messaging | Contact | Send message to users in | Messaging | | Send message to users in |
| | List | a contact list | | | a Buddy List |
| Messaging | Block | Block List used for | Messaging | | Black List used for |
| | List | filtering incoming | | | filtering incoming |
| | (userlist | messages | | | messages |
| | and/or | | | | |
| | grouplist) | | | | |
| | Grant | Grant List used for | | | White List used for |
| | List | filtering incoming | | | filtering incoming |
| | (user-list | messages | | | messages |
| | and/or | | | | |
| | groups- | | | | |
| | list) | | | | |
| | Group | Delivery List: Send | | | Send message to users in |
| | | message to users in a | | | a Buddy List |
| | | group | | | |
| Groups | | Chatroom | Chat | | Chatroom |
| (Chat) | Group | Member List (Allow | | | Allow List used to |
| | | List): used to authorize | | | authorize users to a |
| | | users to a chatroom | | | chatroom |
| | Reject | Reject List used to | | | Block List used to |
| | List | authorize members to a | | | authorize users to a |
| | (user-list | chatroom | | | chatroom |
| | and/or | | | | |
| | group- | | | | |
| | list) | | | | |
| Common | Group | Invite group as a list of | Chat | | Invite group as a list of |
| features | | users | | | users |
| Invite | | | | | |
| Common | Group | Search group as a list of | Group | | Get group as a list of |
| features | | users | Manage- | | users |
| Search | | | ment | | |
| N/A | | N/A | Group | | |
| | | | Manage- | | |
| | | | ment | | |

Upon receiving a message from a user conveying a command/ primitive for a group operation on a group in another domain from the user, where the command is per a protocol used in the user domain, a relay according to the invention first tries to (transparently) map the command to the other domain, as explained above. The following table (Table 2) indicates exemplary mappings giving the approximately equivalent primitives in the WV and IMS domains. The group operation protocol in WV is CSP, and in IMS it is XCAP, which is described in draft-ietf-simple-xcap-00.

What follows is an example of a message that a user might send, and then the form of the message after it is “translated” by the relay. An IMS user sends the following message for adding a new user to the WV presence list for the user:

PUT

http://xcap.example.com/services/wv-presence-lists/users/bill/fr.xml?
wv-presence-lists/list[@name=“friends”] HTTP/1.1
Content-Type:text/plain
<entry name=“Bill” uri=“sip:bill@example.com”>

<display-name>Bill Doe</display-name>

</entry>

The above is the form of the message as received by the relay server. The user's message is translated by the relay server into the WV AddGroupMembers message so as to be as follows:

WV-CSP-Message xmlns=“http://www.wireless-village.org/CSP0.1”>

<Session>

<Identification>

<Type>Inband</Type>
<ID>0x0000beaf</ID>

</Identification>
<Transaction>

<Identification>

<Mode>Request</Mode>
<ID>abcd</ID>

</Identification>
<AddGroupMembers-Request>

<GroupID>friends@wv-presence-lists</GroupID>
<Read>

<UserList>

<UserID>sip:bill@example.com</UserID>

</UserList>

</Read>

</AddGroupMembers-Request>

</Transaction>

</Session>

</WV-CSP-Message>

TABLE 2

| WV (CSP) | IMS (XCAP) |
|---|---|
| GetListRequest | GET http://xcap.example.com/wv-services/users/Alice/list.xml?list HTTP/1.1 |
| GetWatcherListRequest | GET http://xcap.example.com/wv- |
| | services/users/Alice/list.xml?list/Watcher/Watcher-target-URI HTTP/1.1 |
| GetBlockedListRequest | GET http://xcap.example.com/wv-services/users/Alice/list.xml?list/ACL/ACL- |
| (=>Block List & Grant | target-URI HTTP/1.1 |
| List) | |
| BlockEntityRequest | PUT http://xcap.example.com/wv-services/users/Alice/list.xml?list/ACL/ACL- |
| | target-URI=″sip:bob@example.com″ HTTP/1.1 |
| CreateListRequest | PUT http://xcap.example.com/wv-services/ users/Alice/list.xml HTTP/1.1 |
| DeleteListRequest | DELETE http://xcap.example.com/wv-services/users/Alice/list.xml?list HTTP/1.1 |
| ListManageRequest | TBD |
| GetGroupProps | GET http://xcap.example.com/wv-sendces/users/Alice/list.xml?List/ACL/ACL- |
| | target-URI HTTP/1.1 |
| SubscribeGroupNotice | PUT http://xcap.example.com/wv- |
| | services/users/Alice/list.xml?list/rights/right=”SUBSCRIBE_TO_CHANGES” |
| | HTTP/1.1 |
| GetMessageList (chat | GET http://xcap.example.com/wv- |
| history) | services/users/Alice/Messagelist.xml?Messagelist/history HTTP/1.1 |
| GetGroupMembers | GET http://xcap.example.com/wv-services/users/Alice/list.xml?list/DL/DL-target- |
| | URI HTTP/1.1 |
| GetGroupAccessList | GET http://xcap.example.com/wv- |
| | services/users/Alice/group.xml?group/ACL/ACL-target-URI HTTP/1.1 |
| KickUser | DELETE http://xcap.example.com/wv- |
| | services/users/Alice/list.xml?list/ACL/ACL-target-URI=″sip:bob@example.com″ |
| | HTTP/1.1 |
| CreateGroup | PUT http://xcap.example.com/wv-services/users/Alice/myGroup.xml HTTP/1.1 |
| DeleteGroup | DELETE http://xcap.example.com/wv-services/users/Alice/myGroup.xml |
| | HTTP/1.1 |
| SetGroupProps | TBD |
| Search (group) | TBD |
| AddGroupMembers | PUT http://xcap.example.com/wv-services/users/Alice/list.xml?list/DL/DL-target- |
| | URI=″sip:bob@example.com″ HTTP/1.1 |
| RemoveGroupMembers | DELETE http://xcap.example.com/wv-services/users/Alice/list.xml?list/DL/DL- |
| | target-URI=″sip:bob@example.com″ HTTP/1.1 |
| SetGroupAccessList | PUT http://xcap.example.com/wv-services/users/Alice/list.xml?list/ACL HTTP/1.1 |
| | (Content-type = xml with ACL list) |

In general, it is possible to have two or more protocols being used in each of the two domains served by a relay server according to the invention. So how would the relay server know which protocol to translate an incoming request to? According to the invention, the relay receives in the URI of the incoming request sufficient information on the target group so that it knows which protocol to translate to. Thus, e.g. if the destination group contains WV in the URI then, since WV uses only one protocol (CSP, used for both addressing and group management), the relay server knows that it has to do the mapping to the WV protocol. If the incoming request has XCAP or WebDAV in the request, then the relay knows it has to look up in the table that includes the mapping guidelines for each protocol. Those guidelines provide a one-to-one mapping for each request type, indicating how each different part of the incoming request is to be translated in providing the outgoing request.

For access by an IMS user to a group hosted by a WV network, the relay would advantageously be the end point for messages on the IMS side (i.e. e.g. would provide final responses in case of SIP messages) and would issue equivalent group management operation to the WV server (hosting the group) in WV domain.

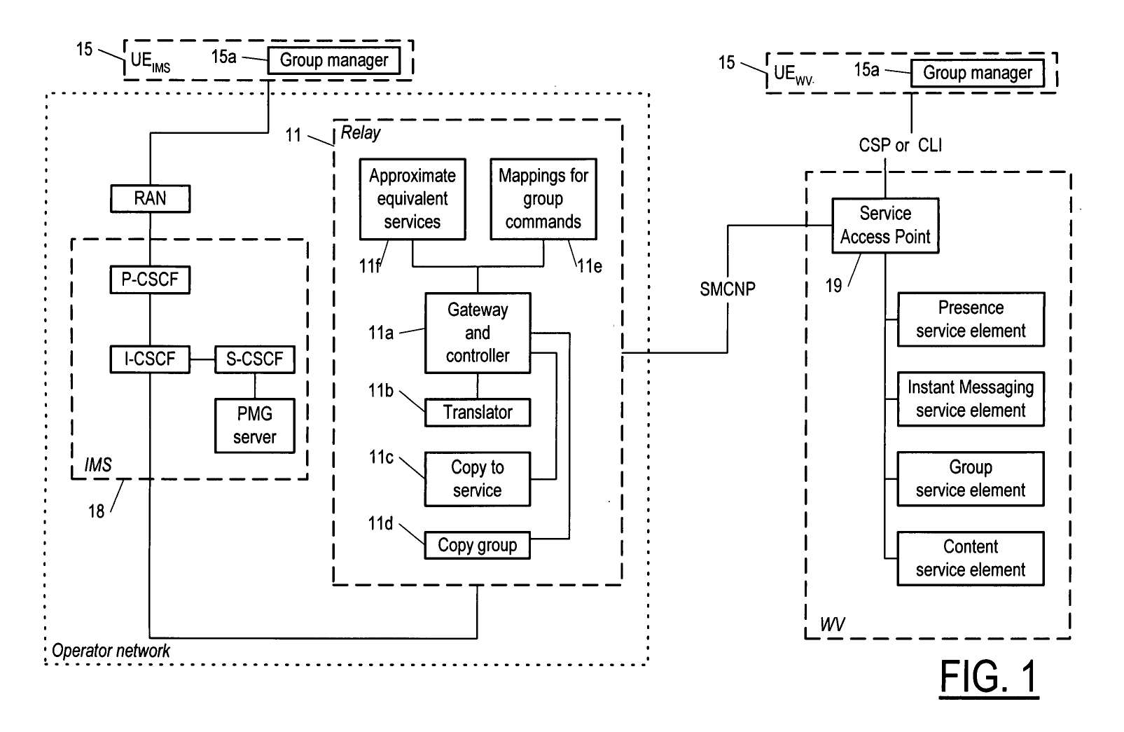

Referring now to FIG. 1, the invention is shown as providing a relay server 11 for converting a message from a user (i.e. from a UE device 15) in one domain addressed to equipment hosting a group in another domain. The two domains shown in FIG. 1 are IMS and WV. The relay server 11 is shown as including a gateway and controller module 11a for controlling three different modules for performing the three different types of responses to an inter-domain group operation message as explained above: a translator module 11b for transparently converting such a message in case of it including mappable group command primitives (so that for the primitive of the message there is an approximately equivalent primitive in the other domains, and also a service that is the an approximately equivalent of the service for which the primitive would be used in the user domain); a copy to service module 11c for copying a group from the other domain to the user domain and binding it to the service in the user domain, as explained above, for use in case an approximately equivalent service exists, but not an approximately equivalent primitive; and a copy group module 11d, for copying a group to a server used by a service indicated by the user in the message, and then notifying the user that the user must (manually) bind the group to the service. FIG. 1 indicates that the controller uses a table 11e of mappable commands and a table 11f of approximately equivalent services in performing its functions of determining whether a command is mappable and determining whether there is an approximately equivalent service in the user domain (respectively), but use of such tables is a design choice. The predetermined information of such mappings and approximate equivalents may be implemented variously, including even in data stores—as records of database systems or as simple tables or data—on other servers.

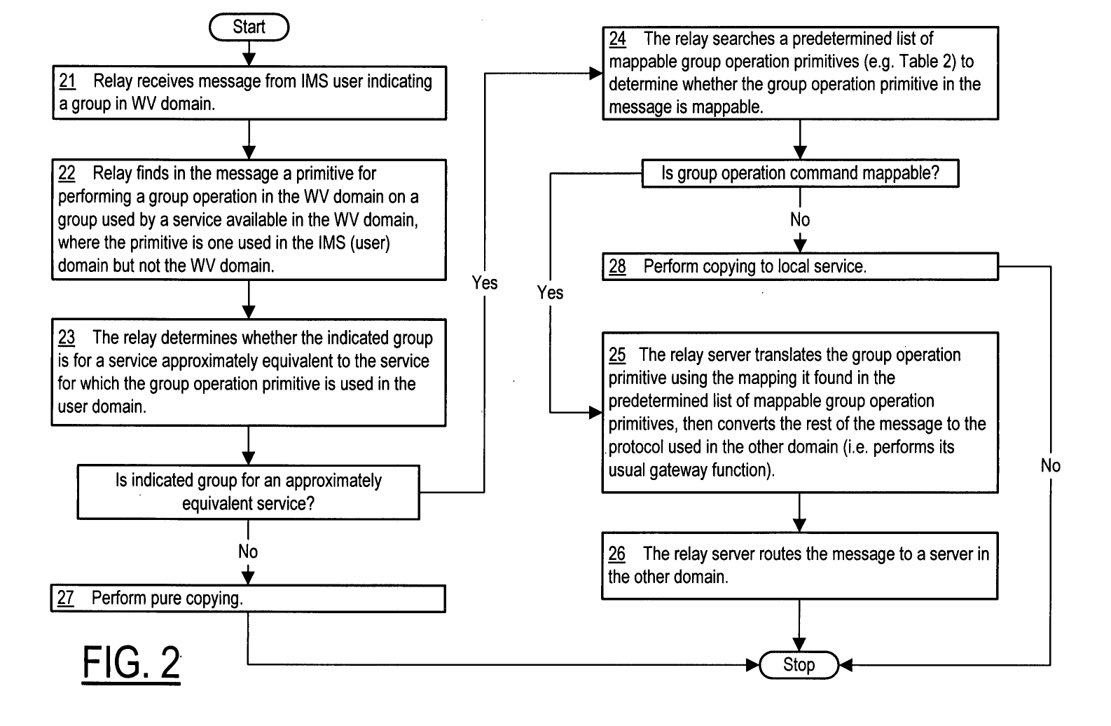

Referring now to FIG. 2, a flowchart illustrating the operation of a relay according to the invention is shown as including a first step 21 in which the relay 11 according to the invention receives a message from an IMS user indicating a group in the WV domain and bearing a group operation primitive for performing an operation on the group in the WV domain. It is assumed here that the group operation primitive is, however, not a primitive recognized by the server hosting the group in the WV domain, but is instead a primitive that would be used in performing a group operation on one or another group in the user domain. In a next step 22, the relay parses the message searching for the group operation primitive and so identifies the group operation primitive. In a next step 23, the relay determines whether the indicated group is for a service approximately equivalent to the service for which the group operation primitive is used in the user domain (using e.g. Table 1 above). (As explained above, the relay determines which group is being indicated in the WV domain from the request URI. The URI includes e.g. the WV schema indicating a WV group and also the group identification—i.e. presence, friends, etc.—and so uniquely identifying the target group.) If the indicated group is for an approximately equivalent service, then in a next step 24, the relay searches a predetermined list of mappable group operation primitives (such as Table 2 above) to determine whether the group operation primitive in the message is mappable. If so, then in a next step 25 the relay server translates the group operation primitive using the mapping it found in the predetermined list of mappable group operation primitives, then converts the rest of the message to the protocol used in the other domain (i.e. performs its usual gateway function), and finally, in a next step 26, routes the message to a server in the other domain—a service access point 19 (FIG. 1) in the WV domain in this case, but in case of a message from a WV user to the IMS domain, to a server 18 (FIG. 1) hosting I-CSCF (interrogating call state control function) functionality for the IMS domain (i.e. a server hosting the functionality used to determine where a message is to be routed in IMS).

Still referring to FIG. 2, if the relay server finds that the indicated group is not for an approximately equivalent service, then instead of performing the step 25 of translating the group operation command, the relay server performs a step 27 of pure copying, as described above. And if as a result of performing the step 24 the relay finds that the group operation command is not mappable, then the relay performs a step 28 of copying to a local service, as also described above.

The invention has been described above in terms (primarily) of the steps of a method for use by a relay server. The invention also comprehends a corresponding apparatus, i.e. an apparatus for performing the above described steps. Thus, for each step described above, there can be a corresponding module of the corresponding apparatus, although it is also possible for the functionality for performing more than one of the above-described steps to be incorporated into a single module. Such modules may be implemented as hardware, or may be implemented as software or firmware for execution by a processor. In particular, in the case of firmware or software, the invention is provided as a computer program product including a computer readable storage structure embodying computer program code with instructions corresponding to the described method—i.e. the software or firmware—thereon for execution by a computer processor.

According also to the invention, and now referring again to FIG. 1, a UE device 15 must be configured to interface with groups independently of their location (via a relay server according to the invention, in case of groups in another domain). Thus, a UE device subscribed to IMS and according to the invention has in its IMS phonebook both IMS and WV groups in respect to which it issues group management commands using IMS, and conversely if the UE device is subscribed to WV. In issuing a group management command for a WV group, the UE device 15, and typically more usually a group manager module 15a of the UE device, is configured to include in its XCAP (IMS) request all information that needed by the relay sever in order to do the proper mapping (i.e. even if IMS groups do not need a group name or some of the other information, if WV requires a group name or other information, then the UE device must be configured to include the group name or other information in the XCAP request so that the relay server can do the proper mapping). Thus, the UE device 15 includes, typically as part of the group manager module 15a, functionality for providing a group command for managing a group in a destination domain different from the domain to which the UE device is subscribed but using a group command protocol prescribed for use in the domain to which the UE device is subscribed, with the group command including information sufficient to identify the group in the destination domain; and also functionality, responsive to a notice indicating the group command is not mappable to an approximately equivalent command in a destination domain, for providing in response a notice of same for display to a user, the notice indicating that the group information cannot be mapped properly because at least some of the group information is incompatible with group information in the destination domain.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. A method for use by a relay server in enabling a user in one domain to perform a management operation on a group stored in another domain via a message according to a protocol used in the user domain and bearing a group command according to a group operation protocol used in the user domain, but indicating a group of a service provided in the other domain, the method comprising:
a step (22) of identifying the group command in the message; and
a step (24) of determining whether the group command is mappable to one or more group commands in the other domain providing an approximate equivalent to the group operation provided by the identified group command, by comparing the identified group command with a predetermined list (11e) of mappable group commands indicating, for each mappable group command in the one domain, one or more group commands in the other domain.

2. A method as in claim 1, further comprising: a step (25), performed if the identified group command is determined to be mappable to the other domain, of translating the message so as to be in a form used in the other domain, and substituting for the identified group command the one or more group commands in the other domain to which the identified group command is mappable, according to the predetermined list of mappable group commands.

3. A method as in claim 1, further comprising: a step (23) of determining whether the group indicated in the message in the other domain is used by a service that is approximately equivalent to a service in the domain of the user, by comparing the service indicated in the message with a predetermined list (11f) of approximately equivalent services.

4. A method as in claim 3, further comprising: a step (28), performed if the service is found to be included in the list (11f) of approximately equivalent services and so has an approximate equivalent in the user domain using a corresponding type of group but also determining that the group command is not mappable, of copying to a group server hosting the corresponding type of group in the user domain the group in the other domain, followed by a step of binding the group to the approximately equivalent service in the user domain.

5. A method as in claim 3, further comprising: a step (27), performed if the service is not found to be included in the list (11f) of approximately equivalent services, of copying to a group server in the user domain the group in the other domain, followed by a step of notifying the user that the group is available in the user domain but user action is required to bind the group to a service.

6. The method of claim 1, wherein one of the domains is 3GPP IMS, and the other is WV, and further wherein, if the message originates from the 3GPP IMS domain, the group command is provided in a message according to one or another addressing protocol including SIP, PRES, IM, and if the message originates from the WV domain, the group command is provided in a message according to one or another addressing protocol including CSP.

7. The method of claim 6, wherein, if the message originates from the 3GPP IMS domain, the group command is provided according to XCAP, and if the message originates from the 3GPP WV domain, the group command is provided according to the CSP protocol.

8. A computer program product comprising: a computer readable storage structure embodying computer program code thereon for execution by a computer processor in a server, with said computer program code characterized in that it includes instructions for performing the steps of the method of claim 1.

9. An apparatus for use with a relay server in enabling a user in one domain to perform a management operation on a group stored in another domain via a message according to a protocol used in the user domain and bearing a group command according to a group operation protocol used in the user domain, but indicating a group of a service provided in the other domain, the apparatus comprising:
means (22) for identifying the group command in the message; and
means (24) for determining whether the group command is mappable to one or more group commands in the other domain providing an approximate equivalent to the group operation provided by the identified group command, by comparing the identified group command with a predetermined list (11e) of mappable group commands indicating, for each mappable group command in the one domain, one or more group commands in the other domain.

10. An apparatus as in claim 9, further comprising: means (25), for use if the identified group command is determined to be mappable to the other domain, for translating the message so as to be in a form used in the other domain, and substituting for the identified group command the one or more group commands in the other domain to which the identified group command is mappable, according to the predetermined list of mappable group commands.

11. An apparatus as in claim 9, further comprising: means (23) for determining whether the group indicated in the message in the other domain is used by a service that is approximately equivalent to a service in the domain of the user, by comparing the service indicated in the message with a predetermined list (11f) of approximately equivalent services.

12. An apparatus as in claim 11, further comprising: means (28), for use if the service is found to be included in the list (11f) of approximately equivalent services and so has an approximate equivalent in the user domain using a corresponding type of group but also determining that the group command is not mappable, for copying to a group server hosting the corresponding type of group in the user domain the group in the other domain, followed by binding the group to the approximately equivalent service in the user domain.

13. An apparatus as in claim 11, further comprising: means (27), for use if the service is not found to be included in the list (11f) of approximately equivalent services, for copying to a group server in the user domain the group in the other domain, followed by notifying the user that the group is available in the user domain but user action is required to bind the group to a service.

14. An apparatus as in claim 9, wherein one of the domains is 3GPP IMS, and the other is WV, and further wherein, if the message originates from the 3GPP IMS domain, the group command is provided in a message according to one or another addressing protocol including SIP, PRES, IM, and if the message originates from the WV domain, the group command is provided in a message according to one or another addressing protocol including CSP.

15. An apparatus as in claim 14, wherein, if the message originates from the 3GPP IMS domain, the group command is provided according to XCAP, and if the message originates from the 3GPP WV domain, the group command is provided according to the CSP protocol.

16. A system, comprising a relay server (11) including an apparatus as in claim 9, also comprising a UE device (15) for use in one of the domains, and further comprising a routing server (18 19) for examining the message and determining whether the message is directed to the other domain, and if so, for routing the message to the relay server (11).

17. A UE device (15), comprising:
means (15a) for providing a group command for managing a group in a destination domain different from the domain to which the UE device is subscribed but using a group command protocol prescribed for use in the domain to which the UE device is subscribed, the group command including information sufficient to identify the group in the destination domain; and
means (15), responsive to a notice indicating the group command is not mappable to an approximately equivalent command in a destination domain, for providing in response a notice of same for display to a user, the notice indicating that the group information cannot be mapped properly because at least some of the group information is incompatible with group information in the destination domain.
